(19) United States
(12) Patent Application Publication
(10) Pub. No.: US 2008/0011296 A1
(43) Pub. Date: Jan. 17, 2008

(54) Monitor For Cpap/Ventilator Apparatus

(75) Inventor: Stefan Schatzl, Weilheim (DE)

Correspondence Address: NIXON & VANDERHYE, PC, 901 NORTH GLEBE ROAD, 11TH FLOOR, ARLINGTON, VA, 22203, US

(73) Assignee: MAP MEDIZIN TECHNOLOGIE GmbH, Martinsried (DE)

(21) Appl. No.: 11/791,482

(22) PCT Filed: Nov. 24, 2005
(86) PCT No.: PCT/EP05/12577

§ 371 Date: May 24, 2007

(30) Foreign Application Priority Data
Nov. 24, 2004 (DE) 10 2004 056 748.4

(51) Int. Cl. A62B 27/00

(52) U.S. Cl. 128/202.22

(57) ABSTRACT

A monitor for surveying measurement values indicative of a person's breathing, to enable an improved assessment, in terms of conclusiveness and reliability, in the course of a treatment phase or a diagnosis. The monitor has a housing structure defining a gas flow path, a measurement line segment provided in the housing structure and structured to communicate with a breathing gas line segment, a sensor in communication with the gas flow path and structured to generate a signal indicative of the breathing gas flow flowing along the gas flow path, and an electronic recording device to record one or more signals indicative of the breathing gas flow, and/or information derived from them. It thus becomes advantageously possible, in treating a patient by using a CPAP device, for instance, to determine the quality of treatment in an objective and standardized way.

### CROSS-REFERENCE TO RELATED APPLICATION

This application claims the benefit of German Application No. 10 2004 056 748.4, filed Nov. 24, 2004, incorporated herein by reference in its entirety.

### BACKGROUND OF THE INVENTION

The invention is directed to a monitor for surveying measured values that are indicative of a person's breathing, e.g., for use with a CPAP/ventilator apparatus.

Based on Sullivan's discovery that sleep-related breathing problems are often due to airway constrictions that occur during the sleeping phase and to obstructive airway constrictions and can be treated by administering breathing gas, especially ambient air, at an elevated pressure level, devices for administering this breathing gas have accordingly been developed since the 1980s.

Pumping the breathing gas up to this elevated pressure level is predominantly done, in the devices used in practice, by rpm-regulated blowers. These blowers, unlike bulky pumping devices, have a pressure lock through which ambient air can flow into a system segment that is at elevated pressure and can flow back through this lock again during an expiration phase.

The delivery of the pumped breathing gas to a patient is typically done via a flexible breathing gas line and a patient interface, such as a mask. The breathing gas line and the patient interface form part of the system segment that is at elevated breathing gas pressure. In this region, a derivation of CO₂ from the exhaled breathing gas can be achieved by forming defined leakage openings, in the region of the overpressure system segment near the patient, for scavenging this segment.

For adapting the pumping capacity of the blower or regulating the breathing gas pressure, numerous pressure regulation concepts are known. For instance, it is possible in particular to regulate the pumping capacity such that over the entire breathing cycle, largely constant static pressures in the region of the mask are obtained. It is also known to regulate the breathing gas pressure such that during an expiration phase, for instance, the breathing gas pressure is lowered, to lessen the breathing work the patient must do. Devices are also known by which an automatic analysis of the patient's breathing is done continuously, based on software, and the breathing gas pressure is done largely in real time on the basis of this automatic analysis of the instantaneous breathing.

In the diagnosis and/or treatment of sleep-related breathing problems, the use of different devices and device components can cause difficulties in assessing the need for treatment and the success of treatment, and in defining suitable device settings.

### SUMMARY

One aspect of the invention is directed to an apparatus or method for making an improved assessment, in terms of its conclusiveness, reliability and/or applicability, of a patient's breathing in the course of a treatment phase or a diagnosis.

According to one embodiment of the invention, a monitor is provided for surveying signals indicative of a patient's breathing. The monitor has a housing structure (1) defining a gas flow path; a measurement line segment (2) provided to the housing structure (1) and structured to be in communication with a breathing gas line segment; a sensor provided along the gas flow path to generate a signal indicative of the breathing gas flow; and an electronic recording device (3) to record one or more signals indicative of the breathing gas flow, and/or information derived from the one or more signals.

It thus becomes advantageously possible, in treating a patient by using a CPAP device or other ventilator device, for instance, to record and assess the quality of treatment in a neutral and standardized way.

The monitor is preferably embodied as an autonomous recording module. Thus, it can be incorporated into typical breathing gas tubing systems, and, in particular, can be plugged into them. The monitor preferably has its own power supply, which is preferably in the form of a battery device or a rechargeable battery device.

The monitor may include an electronic recording device, e.g., in the form of a memory card or a flash stick. The monitor may be in the form of a module. Further, the monitor can be used in conjunction with a feedback loop to assist with control of a flow generator (e.g., CPAP) or other ventilator. It is possible to provide an interface device on the module, for transmitting the detected signals to an evaluation or monitoring computer system. The interface device may be embodied as a USB interface, a network interface, or in particular as a wireless interface. The interface device may be embodied such that the directly surveyed data and/or the data stored in memory can be read out.

It is possible to design an electronic data processor, provided in the region of the monitor, such that the data processor can be configured in a program-based way (e.g., using software) for a certain detection task or a certain detection concept. For instance, the degree of compression or a certain intermediate evaluation procedure can be defined, preferably in a software-based manner.

The monitor may include a measurement device to survey a signal that is indicative of the breathing gas pressure prevailing at that time.

It is possible to make integral the tubular element, forming the measurement channel, in such a way that this tubular element can advantageously be cleaned and sterilized. The surveying of the flow signal can be done using structures of the kind used as such in pneumotachography equipment.

According to another embodiment, there is provided a flow generator; a patient interface; a breathing gas line segment to communicate the flow generator and the patient interface; and a monitor as described above. The monitor is in communication with the breathing line segment.

### BRIEF DESCRIPTION OF THE DRAWINGS

Further details and characteristics are described in or apparent from the ensuing description in conjunction with the drawings, in which:

FIG. 1 is a perspective view of a preferred embodiment of a monitor according to one embodiment of the invention;

FIG. 2 is a schematic illustration explaining the disposition of the monitor inside a breathing gas path; and

FIG. 3 is a schematic illustration explaining an example of internal structure of the monitor.

### DETAILED DESCRIPTION OF PREFERRED EMBODIMENTS

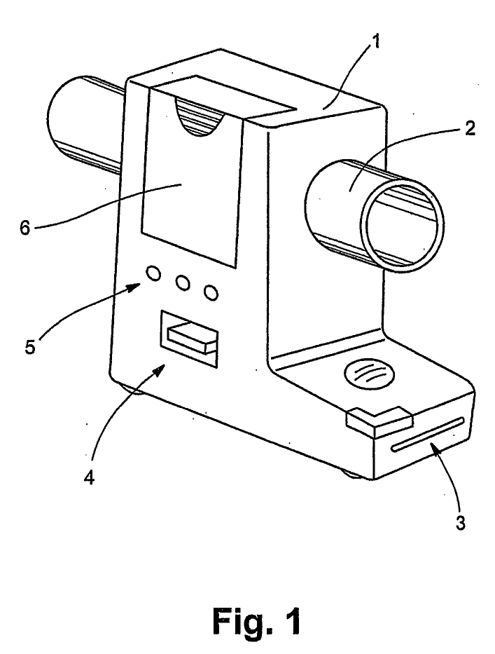

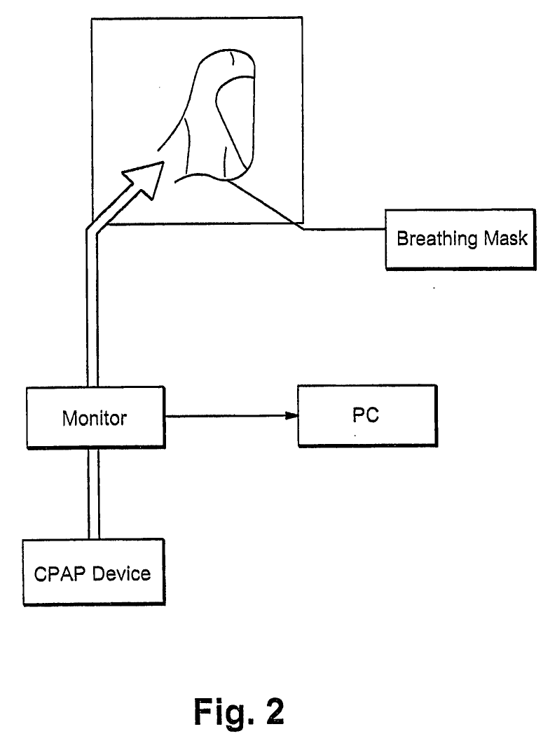

In FIG. 1, a monitor for surveying signals indicative of a patient's breathing is shown. The monitor may have a modular form. The monitor includes a housing structure 1 defining a gas flow path or a measurement section and a measurement line segment 2 that can be coupled to or otherwise in communication with a breathing gas line segment (also known as a gas delivery conduit) (see FIG. 2). The measurement line segment 2 is in communication with a sensor, e.g., a flow measuring instrument (e.g., a flow meter) to generate a signal indicative of the breathing gas flow. The sensor is in communication with the gas flow path. The monitor further includes an electronic recording device 3 for recording signals indicative of the breathing gas flow, or optionally also information derived from them. The monitor preferably is in the form of a module that is functionally, if not physically, positioned between the CPAP device (or other flow generator) and the patient. Information obtained from and/or derived from the monitor can be used as input to the flow generator or ventilator. Thus, the monitor may generate information used in a feedback loop.

The monitor is provided with an interface device 4, which is embodied here simply as a USB port, for example. Via this interface device 4, the measurement signals surveyed in the region of the measurement line segment via the flow measuring instrument can be picked up continuously. It is also possible via the interface device for a data processor, e.g., provided in the monitor, to be configured with a view to a particular kind of data survey that is wanted.

The monitor is also equipped with a display 5, e.g., one or more LEDs. It is possible to activate the LEDs such that one color indicates whether breathing that is obscured by artefacts has already been found in a previous measurement.

The monitor is furthermore powered with a power supply, e.g., in the form of a battery device. The battery device can be changed, once a cover device 6 (positioned over a battery chamber) has been removed. It is also possible for the power supply to be in the form of a rechargeable battery device. The charging of the rechargeable battery device can optionally be done directly via the power that can be tapped in the region of the USB port.

The monitor could also include one or more inputs for oximetry reading.

The monitor is preferably designed such that the recording device, provided for recording the data indicative of the breathing gas flow, is removable from the feedback module for the sake of further signal evaluation. In this exemplary embodiment, the recording device is embodied as a memory card. It is also possible to embody the recording device as a USB flash stick, for example, and the USB flash stick can optionally be connected directly via the USB port provided here.

The monitor preferably includes a pressure detector, for generating a signal indicative of the breathing gas pressure prevailing at that time. Because of the relatively low-frequency chronological fluctuations of the signal, the signal indicative of the breathing gas pressure can be recorded at a lesser data density than the breathing gas flow signal intended for recording the course of respiration. The breathing gas flow signals may be subjected to data compression and stored, for instance in MP3 format or in some other way, in approximated form by means of polynomial functions.

As seen in FIG. 2, the monitor is preferably coupled directly into a segment of the breathing gas line segment that extends between a mask and a CPAP device. The monitor could be classified as an “in-line” monitor, i.e., it is positioned along the gas delivery conduit, between the flow generator (blower) and the mask. The monitor can also be coupled directly to an evaluation circuit, in particular a PC, that is typically more powerful than the electronic circuit device provided in the monitor. It is also possible to design the monitor such that data is forwarded wirelessly, for instance using an IR interface or a Bluetooth™ interface. However, signal conversion and characteristic curve assessment are preferably still done in the region of the monitor, so that regardless of the measured value pickup technology used in the measurement line segment, the flow signal is readable in digital form, being linearized or defined in a standardized way.

Preferably the recording concept executed by the monitor during the observation phase is configurable in a software-based manner.

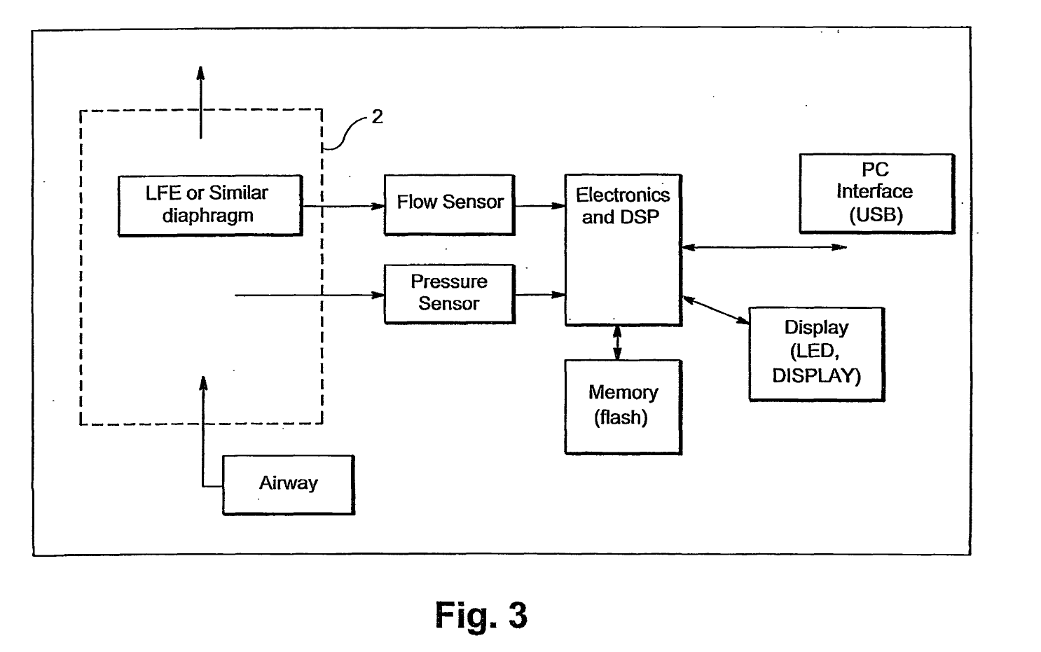

In FIG. 3, the internal structure of a monitor of an embodiment of the invention is shown schematically. Monitor includes measurement line segment 2, described above in conjunction with FIG. 1, provided with a measurement array intended for generating a signal indicative of the breathing gas flow.

The measurement array may be embodied as a ram pressure pickup element, a diaphragm device, or an LFE (laminar flow element). The signals picked up via these corresponding measurement devices can be filtered by a filter device and forwarded to an electronic recording device (digital, programmable electronic memory) provided in the monitor. The monitor shown schematically here also includes a pressure sensor, and the signals surveyed by this pressure sensor are also forwarded to the electronic circuit.

The data based on the measurement signals and generated by the electronic circuit device are stored in a predetermined storage pattern on a preferably replaceable storage medium (in this case a flash memory card). The programming of the evaluation electronics in the equipment can be done via an interface device, in particular a PC interface, such as a USB port. The monitor also includes display devices, such as LEDs or display devices. The display devices may be embodied such that with them, relatively high-quality reproduction of the results of evaluation, or also of raw data, is made possible.

The coupling of the measurement line segment 2 into a suitable breathing gas line system can be done by embodying the measurement line segment 2 such that it is compatible with hose connection cuffs that are known per se.

FIG. 3 shows one example of the basic construction of the monitor. In that portion of the gas path or airway segment defined by the measurement line segment 2, the flow can be measured via a diaphragm or a laminar element. The flow can preferably be measured in both directions with the same precision. The pressure of the breathing gas in this portion of the gas path or airway segment is preferably also measured. This pressure is typically in the range of 0 to 80 hectopascals. The thus surveyed signals can be processed and stored in memory by the electronics. In the memory, both raw data and (preferably) evaluated events are stored. This information can be transmitted and displayed in real time via an interface, e.g., a PC interface. It is also possible, via a display, to pick up or display information directly at the monitor. The evaluation of the measurement signals surveyed with the monitor can be done in a manner known per se by the “Mikro-Mesam” evaluation software developed by the present Applicant.

The monitor is suitable for use not only in the doctor's office but also as a measurement system for performing standardized monitoring of therapy done at home. The monitor makes it possible to analyze and compare most of the various kinds of equipment on the market in terms of their performance, efficiency and/or effectiveness. The monitor may also be used as part of a feedback loop, e.g., it becomes possible to collect data indicative of breathing with high resolution and to use the data for subsequent clinical studies and for developing algorithms for automatic detection of breathing problems or for automatically adapting the breathing gas pressure.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention. Also, the various embodiments described above may be implemented in conjunction with other embodiments, e.g., aspects of one embodiment may be combined with aspects of another embodiment to realize yet other embodiments. In addition, while the invention has particular application to patients who suffer from OSA, it is to be appreciated that patients who suffer from other illnesses (e.g., congestive heart failure, diabetes, morbid obesity, stroke, barriatric surgery, etc.) can derive benefit from the above teachings. Moreover, the above teachings have applicability with patients and non-patients alike in non-medical applications.

1. A monitor for surveying signals indicative of a patient's breathing, comprising:
a housing structure defining a gas flow path;
a measurement line segment provided to the housing structure and structured to be in communication with a breathing gas line segment;
a sensor provided along the path to generate a signal indicative of the breathing gas flow; and
an electronic recording device to record one or more signals indicative of the breathing gas flow, and/or information derived from the one or more signals.

2. The monitor in accordance with claim 1, wherein the electronic recording device is removable from the housing structures.

3. The monitor in accordance with claim 1, further comprising an interface device to dock a further electronic programming or evaluation system.

4. The monitor in accordance with claim 3, wherein the further electronic programming or evaluation system includes a PC.

5. The monitor in accordance with claim 3, wherein the interface device includes a USB port provided to the housing structure.

6. The monitor in accordance with claim 1, further comprising a pressure detector to generate one or more signals indicative of the breathing gas pressure.

7. The monitor in accordance with claim 1, wherein the electronic recording device comprises an evaluation module to effect evaluation in advance of the recorded measurement signals.

8. The monitor in accordance with claim 7, the evaluation module comprises a software-based evaluation system.

9. The monitor in accordance with claim 1, wherein the monitor is an on-line monitor having a modular structure.

10. The monitor in accordance with claim 1, further comprising a display provided to the housing structure.

11. The monitor in accordance with claim 1, further comprising a power supply.

12. The monitor in accordance with claim 11, wherein the power supply is a battery or a re-chargeable battery.

13. The monitor in accordance with claim 11, further comprising a cover device provided to the housing structure to provide access to a battery chamber provided to the housing structure.

14. The monitor in accordance with claim 1, wherein the recording device comprises a USB flash stick or memory card.

15. The monitor in accordance with claim 1, wherein the measurement line segment is in communication with or provided with a measurement array.

16. The monitor in accordance with claim 15, wherein the measurement array includes a pressure pick up element, a diaphragm device and/or a laminar flow element.

17. The monitor in accordance with claim 1, wherein the signals generated and/or derived from the monitor are used as part of a feedback loop.

18. A CPAP or ventilator system comprising:
a flow generator;
a patient interface;
a breathing gas line segment to communicate the flow generator and the patient interface;
a monitor as claimed in claim 1, said monitor being in communication with the breathing line segment.
